(19) United States
(12) Patent Application Publication
(10) Pub. No.: US 2002/0041666 A1
(43) Pub. Date: Apr. 11, 2002

(54) METHOD AND APPARATUS TO ELIMINATE UNWANTED PREDICTIVE DIALER INITIATED TELEMARKETING CALLS

(76) Inventors: MICHAEL P MASTRO, HUNTINGTON BEACH, CA (US); CHUNG TING HO, EDEN PRAIRIE, MN (US)

Correspondence Address: MORLAND C FISCHER, 2030 MAIN STREET, SUITE 1050, IRVINE, CA, 92614

(21) Appl. No.: 09/246,903

(22) Filed: Feb. 8, 1999

(51) Int. Cl. H04M 3/00; H04M 1/66

(52) U.S. Cl. 379/199; 379/188

(57) ABSTRACT

A method by which a line driven, microprocessor controlled special information tone (SIT) generator is coupled to a conventional home or business telephone for generating a set of audible tri-tone signals of the type usually generated by a local telephone exchange carrier when the telephone is not operating properly. The method of the present invention has particular application for preventing unsolicited telemarketing calls from reaching the telephone of an intended recipient. More particularly, the predictive dialer that usually initiates the telephone call from a telemarketer is fooled into mistakably interpreting the set of audible tri-tone signals from the tone generator to mean that the telephone of the intended recipient is not available to the telemarketer, whereby the telemarketer's call will be automatically terminated without the telemarketer being placed in direct communication with the intended recipient.

### BACKGROUND OF THE INVENTION

1. Field of the Invention

This invention relates to a method and to a special information tone (SIT) generator by which to eliminate unsolicited telemarketing telephone calls that are initiated by a predicative dialer of an automated computer system by means of fooling the predictive dialer into believing that a call from a telemarketer has been placed to a telephone which is disconnected or no longer in service.

2. Background Art

Receiving unsolicited and unexpected telephone calls at home or at a place of business from a telemarketer can be an annoying and inconvenient experience. That is to say, such telemarketing calls usually waste the time of the recipient and are often made by a high pressure salesperson who tends to badger the recipient of the call. In many cases, the recipient is forced to hang up on the telemarketer in order to terminate the call. Unfortunately, there is no simple and reliable way for the recipient or his home/business telephone to be able to detect in advance that an incoming call is made by a telemarketer so as to shield the recipient from the inconvenience of first having to stop his current activity, answer the telephone call, and then waste time conversing with the telemarketer.

Therefore, what is needed is a low cost, simple to use apparatus which can be easily attached to any home or business telephone in order to prevent a telemarketer from being placed into direct communication with the intended recipient of the telemarketer's call so as to avoid wasting the time and patience of the recipient. Reference may be made to the Allen U.S. Pat. No. 4,429,188 and Novak U.S. Pat. No. 4,266,098 for examples of devices which attempt to screen incoming calls by requiring that the caller first enter a particular predetermined code before he will be connected to the recipient of his call. If the caller does not know or successfully enter the code at the appropriate time, he will not be able to talk directly with the recipient.

The Walpole U.S. Pat. No. 5,029,198 describes apparatus for eliminating unwanted telephone calls including those made by a telemarketer. User activated control keys are selectively operated by the recipient to generate one of a plurality of prerecorded audible messages with the hopes of causing the caller to terminate the call in response to the particular message delivered by the recipient.

### SUMMARY OF THE INVENTION

In general terms, a method is disclosed by which a microprocessor controlled special information tone (SIT) generator is coupled to a conventional home or business telephone so as to generate a set of audible tri-tones signals, whereby to prevent the unsolicited and annoying calls of a telemarketer from reaching the telephone user. Telemarketers commonly use predictive dialers to initiate a series of calls to homes and businesses. The predictive dialer is sensitive to the status of the telemarketer's call such that if the predictive dialer determines that a telephone is disconnected or out of service, the call will be automatically terminated, whereby the telemarketer is not placed in contact with the intended recipient of the call.

The special information tone generator of the present invention is responsive to the ring voltage at the telephone that occurs during an incoming call so as to generate a set of audible tri-tones of the kind that are commonly used by telephone exchange carriers (i.e. local telephone companies) to indicate an abnormal operating condition, such as that the telephone of the intended recipient is not in service or has been assigned to a different telephone number. The predictive dialer detects this set of tri-tones and mistakenly interprets the tones to mean that the recipient's telephone will not be available to the telemarketer. Accordingly, the predictive dialer causes the call to be terminated without the telemarketer gaining access to the intended recipient.

The special information tone generator is controlled by a microprocessor that is adapted to generate the set of audible tri-tones through a R-2R resistor ladder network provided that the telephone handset is off hook and a ring voltage is detected, such as during an incoming call. By programming the microprocessor, different sets of tones having different tone frequencies may also be generated provided that the predictive dialer will react to such tones.

### BRIEF DESCRIPTION OF THE DRAWINGS

FIG. 1 is a block diagram showing a telephone system which incorporates the microprocessor controlled special information tone generator of the present invention coupled to a home or business telephone to avoid receiving unsolicited calls initiated by a predictive dialer as commonly used by telemarketers; and

FIG. 2 is a schematic circuit of the special information tone generator of FIG. 1 for generating an audible set of tri-tones in response to an incoming telephone call.

### DETAILED DESCRIPTION

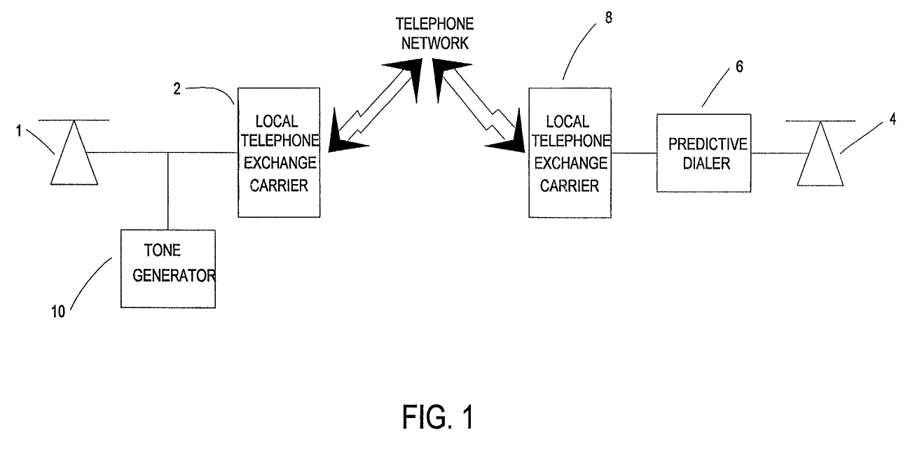

A method and apparatus by which to eliminate unsolicited calls from a telemarketer and which form the present invention are now disclosed in detail while referring initially to FIG. 1 of the drawings where there is shown a telephone system diagram that illustrates a tone generator 10 connected therein. In general terms, a home or business telephone 1 is connected to a local telephone exchange carrier 2 (i.e. the local telephone company to which the home or business telephone user subscribes). The local telephone exchange carrier 2 receives and transmits telephone messages to and from the telephone 1 via an intrastate or interstate telephone network that interconnects the telephone exchange carriers located in different geographic regions.

To conserve the time of a telemarketer and to insure that he will only be placed in contact with a live individual who responds to the telemarketer's call at telephone 1, the telemarketer's telephone 4 is usually coupled to a predictive dialer 6 or to some other commercially available computerized dialing apparatus. The predictive dialer 6 is commonly associated with a computer that enables the predictive dialer to automatically initiate and monitor the status of telephone calls from the telemarketer's phone 4 to the intended recipient's phone 1. Typically, the predictive dialer 6 initiates a sequence of telephone calls taken from a predetermined list of telephone numbers that are compiled to include perspective customers of a telemarketer. The particular telephone number called by the predictive dialer 6 is sent to the telemarketer's local telephone exchange carrier 8 to be transmitted via the telephone network to the local telephone exchange carrier 2 of the recipient and then to the recipient's home or business telephone 1. If and when the outgoing call is completed to the recipient's telephone 1, and the handset is lifted off hook, the telemarketer will be placed in direct communication with the recipient.

However, if the predictive dialer 6 determines that the intended recipient's telephone 1 will not or cannot be answered by a live individual, the outgoing call is automatically terminated and the next call from the predetermined list of telephone numbers will be placed in sequence. By way of example, if the predictive dialer 6 senses a busy signal or an answering machine which indicate that the intended recipient's telephone 1 is in use or that no one is presently available to speak with the telemarketer, the call will be terminated and possibly placed again at a later time.

In some cases, the predictive dialer 6 senses a well known set of audible tri-tone signals having different frequencies which indicate an abnormal operating condition, such as that the intended recipient's telephone 1 has been disconnected or has been assigned to a new telephone number. In this situation, not only is the outgoing call automatically terminated, but the original telephone number dialed by the predictive dialer 6 is frequently eliminated altogether from the predetermined list of telephone numbers stored by the predictive dialer. In fact, since it appears to the predictive dialer 6 that the recipient's telephone 1 is no longer in service, the recipient's telephone number may also be eliminated from the lists of telephone numbers that have been compiled for other telemarketers. The effect of the foregoing is to prevent a telemarketer from reaching the intended recipient of the telemarketer's call.

According to the present invention, a microprocessor controlled special information tone (SIT) generator 10 is coupled to a home and/or business telephone 1 so as to be responsive to all incoming calls over telephone exchange carrier 6. As will be explained in greater detail hereinafter, the tone generator 10 senses when the telephone handset is off hook and when a ring voltage is present during an incoming call to generate a set of audible tri-tones of the kind and frequency which are commonly used by the local exchange carrier 6 to indicate to a caller that the recipient's telephone has been disconnected or is not in service at the number to which the call has been placed or is not in proper operation. It is the function of the tone generator 10 of this invention to spoof or fool the predictive dialer 6 used by the telemarketer into thinking that the intended recipient's telephone will not be answered by a live individual. In other words, the predictive dialer 6 is conditioned to respond to the set of audible tri-tones generated by the tone generator 10 so as to mistakenly interpret the tones to mean that the intended recipient's telephone 1 cannot be accessed by the telemarketer, whereby to cause the call to be automatically terminated and thereby prevent the telemarketer from being placed in contact with or have an opportunity to speak to the recipient.

The set of audible tones from the generator 10 has no effect other than to fool the predictive dialer as to the true status of the recipient's telephone 1. Accordingly, once the tri-tone signals have been generated, the recipient may accept the incoming call in the usual fashion and speak with the caller. At this point, however, it is unlikely that the telemarketer will be on-line or that the recipient will be placed in direct contact with any caller who uses a predictive dialer to initiate the call.

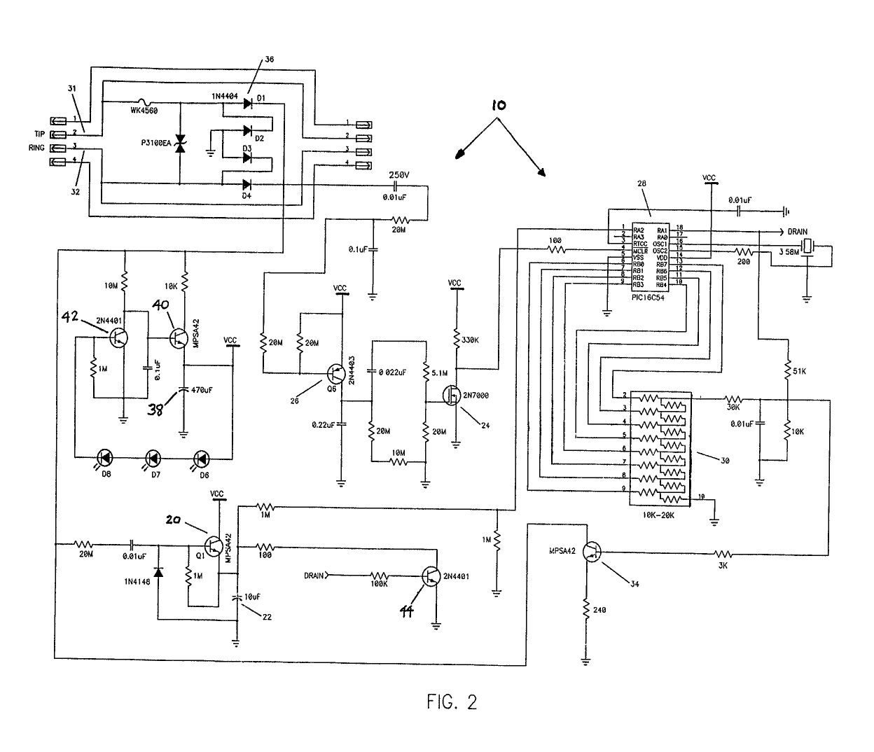

Turning now to FIG. 2 of the drawings, a schematic circuit is shown by which to implement the microprocessor controlled special information tone (SIT) generator 10 of FIG. 1 that generates a set of audible tri-tone signals to spoof the predictive dialer 6 into terminating the call from a telemarketer. The tone generator 6 includes a transistor 20 that is connected as an emitter follower and is responsive to an incoming call (i.e. ring voltage detection) to the telephone 1 of the intended recipient of the telemarketer's call as initiated by the predictive dialer 6. A capacitor 22 which is coupled to transistor 20 is charged by the ring voltage during the incoming call. Transistors 24 and 26 are responsible for detecting the off hook condition when the intended recipient removes his handset from telephone 1. When such an off hook condition is detected, transistor 24 generates a reset pulse to wake-up the microprocessor 28 of tone generator 10.

Once it is awakened by the reset pulse from the transistor 24, the microprocessor 28 generates a set of tri-tones, provided that capacitor 22 has first been charged by the ring voltage from an incoming call. The microprocessor generates the appropriate tones by means of supplying an 8-bit digital output to respective inputs of an eight-input R-2R resistor ladder network 30. The output of resistor ladder network 30 is coupled to the Tip-Ring wires 31 and 32 of the telephone 1 via transistor 34 and a full wave diode bridge 36.

The frequencies that are typically associated with the audible set of tri-tones described above are 950 Hz, 1400 Hz and 1800 Hz. As will be known to those skilled in the art, the microprocessor 28 of tone generator 10 replicates a sine wave at the desired frequency. Depending upon the particular frequency of the tone to be generated, different predetermined amplitude samples between 0 and 255 are taken along the sine wave and stored in a look-up table in an 8-bit format. The microprocessor 28 looks up successive valves of amplitude every 30.86 microseconds and outputs the value to respective ones of the eight input terminals of the R-2R ladder network 30.

The number of entries in each look-up table for each waveform corresponding to each frequency depends upon the period of the tone. For example, an 1800 Hz tone has a period of 55.56 milliseconds which, when divided by the aforementioned sampling time of 30.86 microseconds, results in a total of 18 samples per period. Similarly, a 1400 Hz tone has 23 samples per period, and a 940 Hz tone has 34 samples per period. When the microprocessor 28 reaches the end of a look-up table, it jumps back to the beginning and repeats the same process until a full tone length has been achieved, at which point the microprocessor either generates a subsequent tone or goes into a sleep mode.

Although it is preferable to generate a well known set of audible tri-tones, it is to be expressly understood that the microprocessor 28 can be programmed to generate any number of tones having different frequencies. However, the set of tones produced by tone generator 10 must be able to convince the telemarketer's predictive dialer that the intended recipient's telephone has an abnormal operating condition to which the predictive dialer will be responsive so as to automatically terminate the call.

It should be appreciated that tone generator 10 is line powered and requires no independent battery supply. Capacitor 38 is charged to 5.3 volts (i.e. stepped down from a positive supply voltage of about 50 volts) by transistor 40. The voltage is regulated by light emitting diodes D6, D7 and D8 and transistor 42. When tone generator 10 is connected to the intended recipient's telephone line, it will initially draw several milliamps of current for about one second, and then the current draw will settle down to about seven microamps. Transistor 44 functions to drain the ring voltage on capacitor 22 each time that the microprocessor 28 changes state from sleep to wake.

We claim:

1. A method for an intended recipient to avoid receiving an incoming telephone call made by a computerized dialing apparatus and transmitted to the telephone of the intended recipient via a telephone network, said method comprising the step of generating a signal over the telephone network to cause the computerized dialing apparatus to mistakenly interpret said signal to mean that the telephone of the intended recipient is disconnected from the telephone network or out-of-service or has an abnormal operating condition, whereby the computerized dialing apparatus will terminate the incoming call to the telephone of the intended recipient.

2. The method recited in claim 1, wherein the signal generated over the telephone network includes an audible tone.

3. The method recited in claim 1, wherein the signal generated over the telephone network includes a plurality of tones having different frequencies.

4. The method recited in claim 1, wherein the signal generated over the telephone network includes a set of audible tri-tones of the type generated by a telephone exchange carrier to indicate that a telephone is disconnected or out of service or has an abnormal operating condition.

5. The method recited in claim 4, including the additional step of connecting a tone generator to the telephone of the intended recipient to generate the set of audible tri-tones over the telephone network.

6. The method recited in claim 5, wherein the tone generator that is connected to the telephone of the intended recipient is a special information tone generator.

7. The method recited in claim 6, wherein said special information tone generator is controlled by a microprocessor that is responsive to both the ring voltage generated when an incoming call is made to the intended recipient's telephone and to the status of the handset of the recipient's telephone, said special information tone generator adapted to produce said set of audible tri-tones in the event that said microprocessor thereof detects both a ring voltage and that the handset of the recipient's telephone is off hook.

8. The method recited in claim 7, wherein said special information tone generator is powered from the telephone line to which the intended recipient's telephone is connected.
